(19) United States
(12) Patent Application Publication
(10) Pub. No.: US 2007/0031050 A1
(43) Pub. Date: Feb. 8, 2007

(54) Method and apparatus for bit rate control for image encoding

(75) Inventor: Dae-Kyu Shin, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/492,438

(22) Filed: Jul. 25, 2006

(30) Foreign Application Priority Data
Jul. 25, 2005 (KR) 2005-67514

(51) Int. Cl. G06K 9/36

(52) U.S. Cl. 382/239

(57) ABSTRACT

In a method and an apparatus for bit rate control for image encoding, an entire screen is divided into a high screen quality region and a low screen quality region, a larger number of bits are allocated to the high screen quality region than to the low screen quality region, and the bit rated is controlled according to such allocation. Therefore, the method and the apparatus can provide a screen having areas with different qualities according to a user's setup.

### PRIORITY

This application claims the benefit under 35 U.S.C. §119(a) of an application entitled “Method And Apparatus of Controlling Bit Rate in Image Encoding” filed in the Korean Intellectual Property Office on Jul. 25, 2005 and assigned Serial No. 2005-67514, the contents of which are incorporated herein by reference.

### BACKGROUND OF THE INVENTION

1. Field of the Invention

The present invention relates to a method and an apparatus for encoding for motion picture image compression, and more particularly to a method and an apparatus for bit rate control in motion image coding, which control bit rates allocated in the case of acquiring reconstructed images by coding and decoding images.

2. Description of the Related Art

Development of communication technology has now led to rapid development of motion image compression technology, multimedia transmission technology, etc. Moreover, wide distribution of picture-taking apparatuses such as digital cameras has led to development of technology for transmission of motion image data to an external device connected to a picture-taking apparatus. Further, there appears to be a strong demand for a mobile phone by which a user can make an image communication with a counterpart while viewing a face of the counterpart as well as hearing the voice of the counterpart.

In order to satisfy such a demand, image compression technologies, such as Motion Picture Expert Group 1 (MPEG-1), MPEG-2, MPEG-4, and H.263, have been proposed and are realizing and commercializing the image communication through mobile phones.

In general, there are two kinds of methods for compressing video signals, which include intra-frame compression and inter-frame compression.

The intra-frame compression refers to a method for compressing information within one video frame, a kind of which is the Discrete Cosine Transform (DCT) method. According to the DCT method, the correlation of data is eliminated through two dimensional axis transform. To this end, an input frame is divided into blocks and an image of each block is then converted from a space domain to a frequency domain. Here, the converted data tend to flock in one direction, that is, toward the low frequency area, and a quantizer quantizes the flocking data, so as to eliminate spatial redundancy.

The inter-frame compression refers to a compression method which eliminates the temporal redundancy by coding images based on differences of corresponding pixel values between consecutive video frames. Temporally consecutive images have movement of human beings or material objects only at a central portion of a screen without change in its background. Therefore, it is possible to remove the temporal redundancy by using such a characteristic. That is, it is possible to significantly reduce the quantity of data by referring to a previous image instead of encoding the portion which either has no change or is nearly the same as that in the previous image. This method is called Motion Estimation (ME) technology. Nearly all image encoding standards, which include H.261, MPEG-1, MPEG-2, H.263, MPEG-4, etc., employ the ME technology for the inter-frame compression.

Now, demands for portable terminals including portable phones, PDAs, etc., and motion image services in low bit-rate environment and channels of a bandwidth having variable size according to time are increasing. Since motion images occupy a large capacity and require a large memory differently from other data, they are transmitted after being compressed according to worldwide predetermined standards.

In compression of motion images, adaptive encoding according to the bandwidth or the variable channel environment relates to a bit rate control technique of images.

In general, the bit rate control is focused on the processing of Macro Blocks (MBs) under an assumption of a constant frame rate. However, in the low bit rate environment, usable bits are limited and the assumption of the constant frame rate may thus be improper for the image compression technology.

Further, in relation to the image encoding/decoding, for evaluation of picture quality, not only numerical comparison values such as Peak Signal to Noise Rate (PSNR) are necessary, but also subjective judgment by a user's naked eye needs to be taken into account. Therefore, improved bit rate control is necessary in order to prevent blocking or flickering of images, which may occur during the process of encoding with a fixed frame rate.

According to MPEG-4 or H.263 image CODECs, which are worldwide motion image standards, motion image frames are encoded through entropy coding after quantization. Therefore, the size of an encoded bit stream is not constant, and a signal having a bit rate of variable size is input through a wire or wireless communication channel. At this time, by the bit rate control, it is possible to select a proper encoder parameter, i.e. a proper quantization coefficient, for generation of a bit stream which does not have an overflow exceeding a predetermined bit size defined by a buffer between an encoder, a decoder, and communication channels. The process for the bit rate control is as follows.

First, bits allocated to each frame generated during one second are obtained by using allocated bits per each second and frames per each second. From the bits allocated per second, the bits other than the bits allocated to the Intra-frames (I-frames) are uniformly distributed to the remaining Predictive frames (P-frames) generated within one second. Further, the bits allocated to each of the P-frames are uniformly distributed to a plurality of macro-blocks constituting the corresponding P-frame. Thereafter, when the number of bits allocated to one macro-block is larger than the number of actually generated bits in the macro-block, the quantization coefficient is decreased. In contrast, when the number of allocated bits is smaller than the number of actually generated bits, the quantization coefficient is increased. Here, the quantization coefficient of an already encoded neighboring macro-block serves as a basic quantization coefficient which is a reference for the increase or decrease of the quantization coefficient. By using the quantization coefficient determined in the way as described above, a Discrete Cosine Transform (DCT) coefficient of the corresponding DCTed macro-block is quantized, so that it is encoded. However, the conventional bit rate control process for determining the quantization coefficient is based on the allocated bit rates without taking the screen quality into consideration, so that the screen quality is not uniform both temporally and spatially. In other words, one screen may include both a portion having a high screen quality and another portion having a low screen quality, or one screen may have a high screen quality while another screen has a low screen quality. Further, because average bits are allocated to the entire screen, the encoding is performed without difference for the desired region (e.g. a face of a user in image communication) and the other region (e.g. the background region), so as to produce a screen with a low quality on the whole, as shown in FIG. 5 which shows an example of a screen obtained through the conventional bit rate control process. According to the conventional bit rate control process, the first screen 401 may be displayed as the second screen 403 which is unclear on the whole, as shown in FIG. 5. Therefore, a new bit rate control process capable of providing a higher screen quality especially for a desired area appointed by a user is necessary.

### SUMMARY OF THE INVENTION

Accordingly, the present invention has been made to solve the above-mentioned problems occurring in the prior art, and an object of the present invention is to provide an improved method and apparatus for bit rate control in image encoding.

It is another object of the present invention to provide a method and an apparatus for bit rate control in image encoding, which can provide an image having a portion with a higher screen quality.

It is still another object of the present invention to provide a method and an apparatus for bit rate control in image encoding, which can provide an image having a portion with a higher screen quality than that of the other portion of the image according to a user's setup.

It is still another object of the present invention to provide a method and an apparatus for bit rate control in image encoding, which can allocate an increased number of bits to a portion of an image and a decreased number of bits to the other portion of the image according to a user's setup, thereby maintaining a high screen quality for the portion of the image while lowering the screen quality of the other portion.

In order to accomplish this object, there is provided a method for bit rate control for image encoding, the method including dividing an entire screen into a high screen quality region and a low screen quality region and allocating a larger number of bits to the high screen quality region than to the low screen quality region; encoding a current area based on a general quantization coefficient of the current area when the current area belongs to the high screen quality region, wherein the general quantization coefficient is determined based on a comparison value between actually generated bits and bits allocated to the current area and based on a quantization coefficient of a corresponding area of a previously encoded frame; and encoding the current area by using a final quantization coefficient determined by comparing the general quantization coefficient with a maximum quantization coefficient when the current area belongs to the low screen quality region and is located adjacent to the high screen quality region, wherein the maximum quantization coefficient is predetermined based on a quantization coefficient of a high screen quality region of a previously encoded frame, and encoding the current area by using the final quantization coefficient determined with reference to a quantization coefficient of an already encoded area within a same frame when the current area is not located adjacent to the high screen quality region.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the structure of an image communication apparatus according to the present invention;

FIG. 2 illustrates a construction of an encoder according to the present invention;

FIG. 3 illustrates a process for setting a high screen quality region according to the present invention;

FIG. 4 is a flowchart illustrating a process for bit rate control in image encoding according to the present invention;

FIG. 5 shows an example of screens obtained through the conventional bit rate control process; and

FIG. 6 which illustrates a screen including a high screen quality region set according to the present invention and a screen quality difference due to the setup of the high screen quality region.

### DETAILED DESCRIPTION OF THE PREFERRED EMBODIMENTS

Hereinafter, preferred embodiments of the present invention will be described with reference to the accompanying drawings.

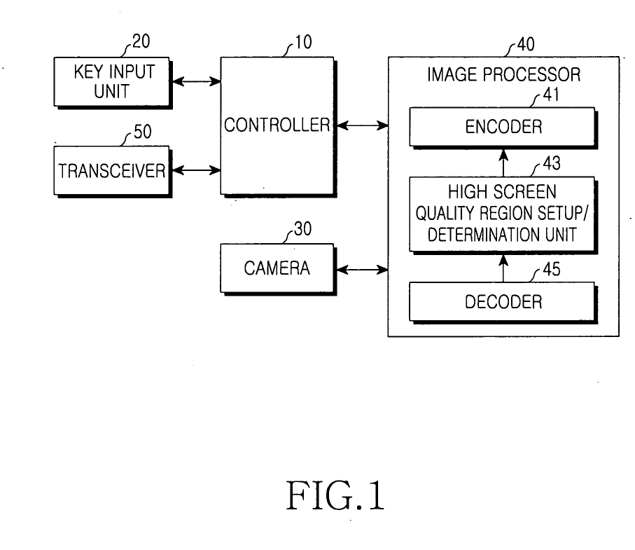

First, a structure of an image communication apparatus having a bit rate control apparatus according to the present invention will be described with reference to FIG. 1, which is a block diagram illustrating the structure of an image communication apparatus. Referring to FIG. 1, the image communication apparatus includes a controller 10, a key input unit 20, a camera 30, an image processor 40, and a transceiver 50.

The controller 10 controls general operation of the image communication apparatus and outputs key input data, which are input through the key input unit 20, to the image processor 40. The key input unit 20 includes number keys of 0˜9, keys of * and #, direction keys, and a plurality of function keys for various functions including menu, selection, communication, deletion, power/end, volume, etc., which the mobile communication terminal has. The key input unit 20 provides key input data corresponding to a key pressed by a user to the controller 10. The transceiver 50 transmits/receives data for image communication under the control of the controller 10. The camera 30 outputs an image signal obtained by an image sensor under the control of the controller 10. The image processor 40 encodes or decodes image signal input from the camera 30 or image data received through the transceiver 50, so as to provide an image.

In the image communication apparatus having the structure as described above, an image signal input through the camera 30 is encoded into image data by the image processor 40, and the converted image data are then transmitted through the transceiver 50 to an image communication apparatus of a counterpart. Also, received image data from the image communication apparatus of the counterpart are decoded and output as an image by the image processor 40.

The image processor 40 includes an encoder 41, a high screen quality region setup/determination unit 43, and a decoder 45. The encoder 41 encodes the image signal acquired by the camera 30 into image data according to bit rate control by the high screen quality region setup/determination unit 43. The decoder 45 decodes received image data into an image, enlarges the decoded image under the control of the high screen quality region setup/determination unit 43, and outputs the enlarged image to a display unit (not shown).

The high screen quality region setup/determination unit 43 sets a high quality region and a low quality region in an image according to key input data input by the controller 10 in response to a user's operation. The high quality region refers to a predetermined region of a displayed screen, which is designated by the user to be encoded to have a higher screen quality than the other region. The low quality region refers to the remaining region other than the high quality region in the entire display screen. According to the present invention, the high quality region may be set up according to the user's key operation, and the basic unit for division of regions for the setup of the high quality region may be a macro-block. Further, the high screen quality region setup/determination unit 43 adjusts the bit rates to be allocated to the high quality region and the low quality region according to the user's request and controls the bit rates based on the allocated bit rates in encoding the image signal.

The high quality region and the low quality region can be set up according to the following process. When there is a demand for screen quality adjustment setup from the user, the high screen quality region setup/determination unit 43 provides, in cooperation with the controller 10, a menu for setup of an entire screen provision mode and a selective screen provision mode. The entire screen provision mode refers to a mode for encoding both the high screen quality region and the low screen quality region, which are divided according to a user's selection, into image data in an entire displayable screen according to the present invention. The selective screen provision mode refers to a mode for encoding only the high screen quality region selected by a user, into image data, while skipping encoding of the low screen quality region in the entire displayable screen.

When the entire screen provision mode has been selected by a user, the high screen quality region setup/determination unit 43 provides, in cooperation with the controller 10, a basic screen for setup of a high quality region. The basic screen for setup of the high quality region includes a displayable entire screen, and an area setting square having a size and a location which can be controlled by a user's key operation on the entire screen. The user can perform a key operation to set and adjust the high screen quality region while identifying the area setting square. Here, the minimum unit of the area setting square is the macro block. The high screen quality region setup/determination unit 43 sets the area, on which the area setting square is placed by the user's key operation, as the high screen quality region. Thereafter, in response to a request for setup of the screen quality of the high screen quality region, the user performs a key operation for setup of the screen quality, for example, operation of up/down keys. In response to the key input data, the high screen quality region setup/determination unit 43 increases or decreases the bit rate to be allocated to the high screen quality region in encoding. In setting the screen quality of each region, the high screen quality region setup/determination unit 43 decreases the bit rate to be allocated to the low screen quality region by the amount corresponding to the increased bit rate for the high screen quality region, and increases the bit rate to be allocated to the high screen quality region by the amount corresponding to the decreased bit rate for the low screen quality region. In this case, in response to the user's key input, the high screen quality region setup/determination unit 43 may instantly change the screen quality of the displayed basic screen for the setup of the high screen quality region, so that the user can instantly confirm the setup screen quality.

Meanwhile, when the selective screen provision mode has been selected by the user, the high screen quality region setup/determination unit 43 provides a formatted high screen quality region selectable by the user and concentrates allocatable bits to the high screen quality region selected by the user. That is, the high screen quality region setup/determination unit 43 allocates actually 0 bits to the low screen quality region, so that the corresponding region is skipped in the encoding. Therefore, the high screen quality region setup/determination unit 43 displays an image decoded by the decoder 45 after enlarging the decoded image by a proper ratio within a range which can prevent distortion of the image, when the decoded image has a size which is smaller than that of an image which can be displayed in the image communication apparatus.

Further, the high screen quality region setup/determination unit 43 outputs the bit rate for the high screen quality region and the bit rate for the low screen quality region, which have been set as described above, to a bit rate control unit 210 included in the encoder 41.

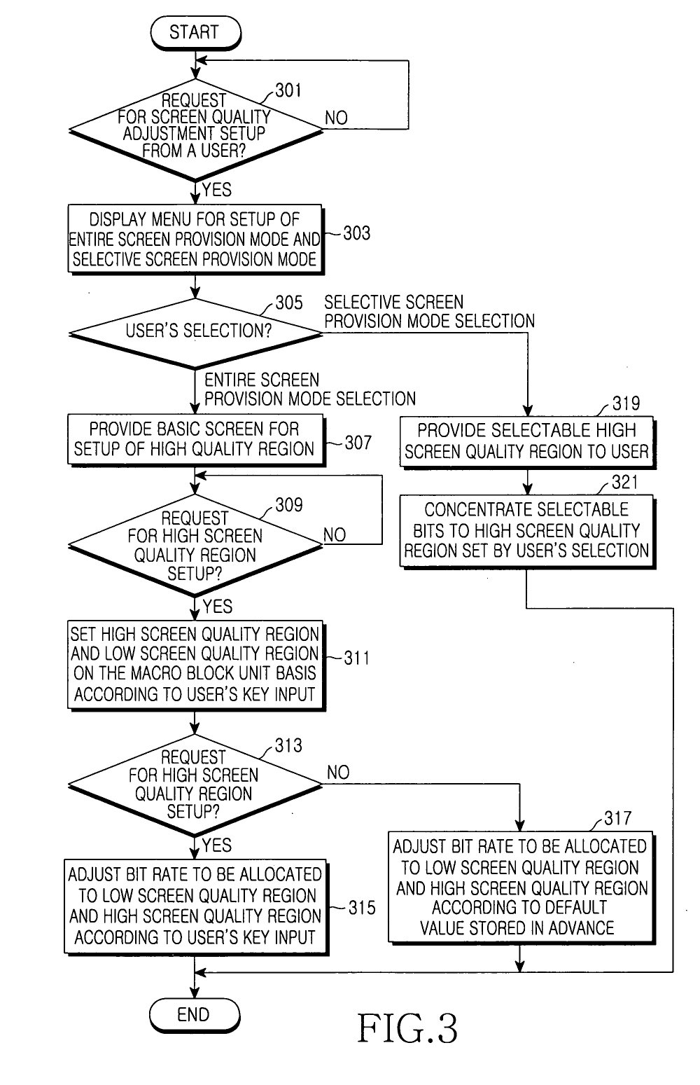

The operation process of the high screen quality region setup/determination unit 43 as described above is shown in FIG. 3, which illustrates a process for setting a high screen quality region according to the present invention. Referring to FIG. 3, when there is a request for screen quality adjustment setup from a user in step 301, the high screen quality region setup/determination unit 43 proceeds to step 303. In step 303, the high screen quality region setup/determination unit 43 displays a menu for setup of an entire screen provision mode and a selective screen provision mode. Then, in step 305, the high screen quality region setup/determination unit 43 determines which is the user's selection. The high screen quality region setup/determination unit 43 proceeds to step 307 when the user has selected the entire screen provision mode, and proceeds to step 319 when the user has selected the selective screen provision mode. In step 307, the high screen quality region setup/determination unit 43 provides a basic screen for setup of a high quality region. Then, in step 309, the high screen quality region setup/determination unit 43 determines if there is a request for a high screen quality region setup. When there is a request for a high screen quality region setup, the high screen quality region setup/determination unit 43 proceeds to step 311. In step 311, the high screen quality region setup/determination unit 43 sets the high screen quality region and the low screen quality region on a macro block unit basis. Then, in step 313, the high screen quality region setup/determination unit 43 determines if there is a request for a high screen quality region setup. The high screen quality region setup/determination unit 43 proceeds to step 315 when there is a request for a high screen quality region setup, and proceeds to step 317 when there is no request for a high screen quality region setup. In step 315, the high screen quality region setup/determination unit 43 adjusts the bit rate to be allocated to the low screen quality region and the high screen quality region according to the user's key input and then stops the process. Meanwhile, in step 317, because there has been no request for a high screen quality region setup in step 313, the high screen quality region setup/determination unit 43 adjusts the bit rate to be allocated to the low screen quality region and the high screen quality region according to the default value stored in advance and then stops the process.

In the meantime, when the user has selected the selective screen provision mode in step 305, the high screen quality region setup/determination unit 43 provides a selectable high screen quality region to the user in step 319 and then proceeds to step 321. The selectable high screen quality region may either include a plurality of predetermined formats or be defined according to appointment by the user. Then, in step 321, the high screen quality region setup/determination unit 43 concentrates the selectable bits to the high screen quality region set according to the user's selection and stops the process.

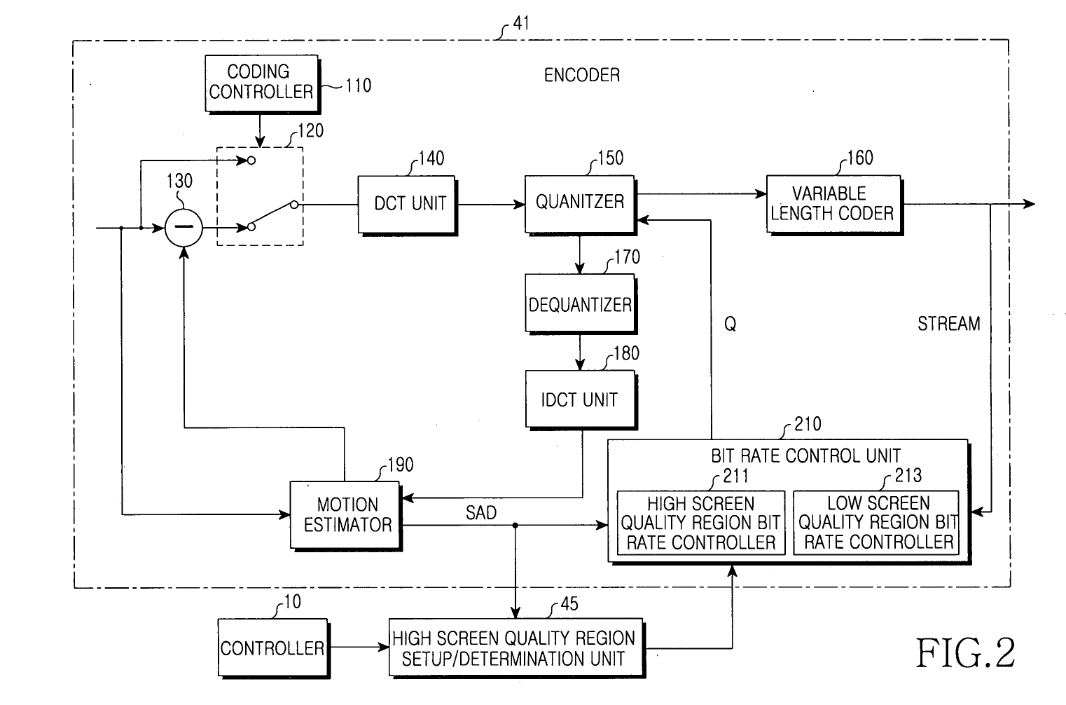

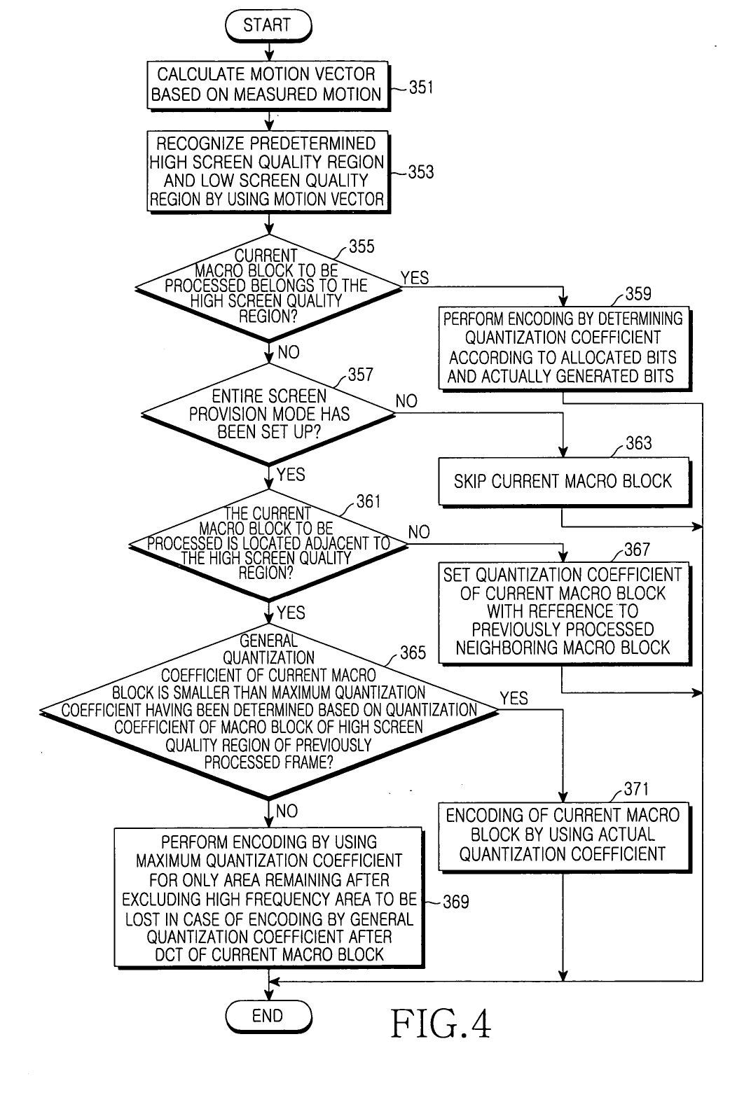

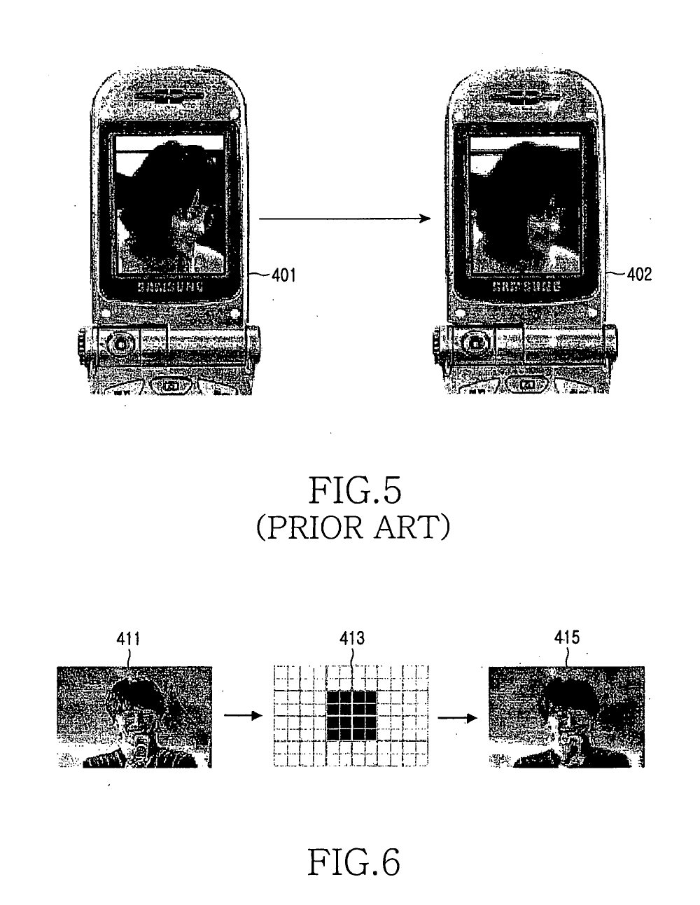

Hereinafter, an encoding process for the high screen quality region and the low screen quality region set through the above-described process will be described with reference to FIGS. 2 and 4. First, a construction of the encoder 41 and an encoding process by the high screen quality region setup/determination unit 43 according to the present invention will be described with reference to FIG. 2. The encoder 41 shown FIG. 2 includes a coding controller 110, a switch 120, a subtractor 130, a DCT unit 140, a quantizer 150, a variable length coder 160, a dequantizer 170, an IDCT unit 180, a motion estimator 190, and a bit rate control unit 210.

The coding controller 110 outputs a control signal for determining the object of the encoding. The switch 120 selects a signal from among the signals input according to the control by the coding controller 110 and outputs the selected signal. The subtractor 130 performs subtraction between an input source image and an image input from the motion estimator 190 and outputs a signal resulted from the subtraction to the switch 120.

The DCT unit 140 performs Discrete Cosine Transform (DCT) on the image selectively output from the switch 120, thereby generating DCT coefficients. The quantizer 150 quantizes the DCT coefficients generated by the DCT unit 140. The quantized DCT coefficients are scanned in a zigzag manner and are then input to the variable length coder 160.

The variable length coder 160 converts the scanned quantized DCT coefficients to variable-length-coded data which are then output as an encoded continuous bit stream by a bit stream generator (not shown).

Meanwhile, the output of the quantizer 150 is input to the dequantizer 170 also. The dequantizer 170 dequantizes the quantized DCT coefficients and outputs them to the IDCT unit 180. The DCT coefficients output from the dequantizer 170 are subject to Inverse Discrete Cosine Transform (IDCT) in the IDCT unit 180.

The motion estimator 190 estimates a motion image by using a difference between an image obtained through IDCT by the IDCT unit 180 and an image from a port before the subtractor 130. The motion estimator 190 calculates a Sum of Absolute Difference (SAD), which is a sum of absolute values of differences between two images, and estimates the motion based on the calculated SAD. The motion estimator 190 outputs the result of the motion estimation to the subtractor 130, and the subtractor 130 calculates the difference between an input image from the outside and an image input from the motion estimator 190 and outputs the calculated difference to the switch 120. Further, the motion estimator 190 outputs the SAD information between the two images, which has been calculated for the motion estimation, to the bit rate control unit 210.

In order to satisfy a target transmission bit rate, under the control of the high screen quality region setup/determination unit 43, the bit rate control unit 210 adjusts the bit rate by determining the quantization coefficients to be used for quantization in the quantizer 150. The bit rate control unit 210 includes a high screen quality region bit rate controller 211 and a low screen quality region bit rate controller 213. The high screen quality region bit rate controller 211 determines the quantization coefficients to be used for encoding of the high screen quality region according to a process similar to a typical quantization coefficient determining process in a typical encoding. The low screen quality region bit rate controller 213 determines quantization coefficients to be used for encoding of the low screen quality region. A process for determining quantization coefficients by the low screen quality region bit rate controller 213 is as follows.

First, for a current macro block to be processed, the low screen quality region bit rate controller 213 sets a maximum quantization coefficient based on the quantization coefficient of a macro block included in the high screen quality region of the previously processed frame, particularly based on the quantization coefficient of a macro block directly adjacent to the macro block included in the low screen quality region. This is because, according to a typical process for the determination of quantization coefficient, the quantization coefficient is determined so as to be within a range of ±2 of the quantization coefficient of the already encoded adjacent macro block. More particularly, if a quantization coefficient of a macro block of a predetermined low screen quality region has been determined to be higher than a predetermined value, the actual quantization coefficient is inevitably determined to have a high value due to the influence of the quantization coefficient of the macro block of the low screen quality region, even when a large number of bits have been allocated to the macro block of the adjacent high screen quality region. As a result, it is meaningless to allocate a large number of bits to the high screen quality region. Therefore, according to the present invention, the low screen quality region bit rate controller 213 determines the maximum quantization coefficient based on the quantization coefficient of a macro block included in the high screen quality region of the previously processed frame, particularly based on the quantization coefficient of a macro block directly adjacent to the macro block included in the low screen quality region.

Thereafter, if a general quantization coefficient of a current macro block to be currently processed (i.e. a quantization coefficient which is determined based on a comparison value between actually generated bits and allocation bits predetermined according to the process shown in FIG. 3, and based on a quantization coefficient of a corresponding macro block at the time of encoding a previous frame, etc.) is smaller than the maximum quantization coefficient, the low screen quality region bit rate controller 213 encodes the current macro block by using the general quantization coefficient. If the general quantization coefficient is larger than the maximum quantization coefficient, the low screen quality region bit rate controller 213 encodes the current macro block by using the maximum quantization coefficient. At this time, the high frequency area to be lost in the case of encoding by the general quantization coefficient after DCT of the current macro block is excluded from and only the other area is subjected to the encoding by using the maximum quantization coefficient by the low screen quality region bit rate controller 213.

According to the present invention, the high screen quality region setup/determination unit 43 recognizes the high screen quality region and the low screen quality region which have been set in advance according to the process shown in FIG. 3 and determines if the currently set mode is the entire screen provision mode or the selective screen provision mode. Further, by using the information from the motion estimator 190, the high screen quality region setup/determination unit 43 determines if the current macro block to be processed belongs to the high screen quality region or the screen quality region. When the current macro block belongs to the high screen quality region, the high screen quality region setup/determination unit 43 controls the bit rate control unit 210 to determine the quantization coefficient by the high screen quality region bit rate controller 211. Further, when the current macro block belongs to the low screen quality region, the high screen quality region setup/determination unit 43 controls the bit rate control unit 210 to either determine the quantization coefficient by the low screen quality region bit rate controller 213 according to a predetermined provision mode or skip the encoding.

FIG. 4 is a flowchart illustrating a process for bit rate control in image encoding according to the present invention.

Referring to FIG. 4, first, the high screen quality region setup/determination unit 43 obtains a motion vector based on measured motion of an entity in step 351. Then, in step 353, the high screen quality region setup/determination unit 43 recognizes predetermined high screen quality region and low screen quality region by using the motion vector. Then, in step 355, the high screen quality region setup/determination unit 43 determines if a current macro block to be processed belongs to the high screen quality region or the low screen quality region. The high screen quality region setup/determination unit 43 proceeds to step 359 when the current macro block belongs to the high screen quality region, and proceeds to step 357 when the current macro block belongs to the low screen quality region. In step 359, the high screen quality region setup/determination unit 43 controls the high screen quality region bit rate controller 211 to perform the encoding by determining the quantization coefficient according to the quantization coefficient of the corresponding macro block of the previous frame, thereby completing the encoding of the current macro block.

In step 357, the high screen quality region setup/determination unit 43 determines if the entire screen provision mode or the selective screen provision mode has been set up. The high screen quality region setup/determination unit 43 proceeds to step 361 when the entire screen provision mode has been set up, and proceeds to step 363 when the entire screen provision mode has been set up. In step 363, the high screen quality region setup/determination unit 43 skips the current macro block without encoding the current macro block, because it is in the state where the current macro block is a macro block of the low screen quality region and the selective screen provision mode has been set up. This is because there is no bit allocated to the current macro block and it is thus actually impossible to perform the encoding.

As a result of the determination in step 357, when the current macro block belongs to the low screen quality region and the entire screen provision mode has been set up, the high screen quality region setup/determination unit 43 determines, in step 361, if the current macro block to be processed is located adjacent to the high screen quality region. The high screen quality region setup/determination unit 43 proceeds to step 365 when the current macro block is located adjacent to the high screen quality region, and proceeds to step 367 when the current macro block is located not adjacent to the high screen quality region. In step 367, the high screen quality region setup/determination unit 43 sets the quantization coefficient of the current macro block with reference to the neighboring macro block previously processed by the low screen quality region bit rate controller 213, thereby completing the encoding of the current macro block.

In step 365, the high screen quality region setup/determination unit 43 determines if a general quantization coefficient of the current macro block is smaller than the maximum quantization coefficient which has been determined based on the quantization coefficient of the macro block of the high screen quality region of the previously processed frame. The high screen quality region setup/determination unit 43 proceeds to step 371 when the general quantization coefficient is smaller than the maximum quantization coefficient, and proceeds to step 369 when the general quantization coefficient is larger than the maximum quantization coefficient. In step 371, the high screen quality region setup/determination unit 43 completes the encoding of the current macro block by using an actual quantization coefficient. In step 369, the high screen quality region setup/determination unit 43 performs encoding by using the maximum quantization coefficient for only the area remaining after excluding the high frequency area to be lost in the case of encoding by the general quantization coefficient after DCT of the current macro block.

Images displayed through the bit rate control in the way described above are shown in FIG. 6, which illustrates a screen including a high screen quality region set according to the present invention and a screen quality difference due to the setup of the high screen quality region. In FIG. 6, the third screen 411 shows the entire actual image, the fourth screen 413 shows a structure including macro blocks for the divided high screen quality region and low screen quality region, and the fifth screen 415 shows an image displayed after encoding of the divided high screen quality region and low screen quality region. As noted from the fifth screen 415, the high screen quality region is clearly displayed while the low screen quality is displayed in a relatively opaque state.

According to the present invention as described above, it is possible to set the high screen quality region and the low screen quality region in an entire screen according to a user's selection, set the bit rate to be higher for the high screen quality region than for the low screen quality region, and perform encoding while controlling the bit rate, so that the present invention can provide a screen including a region with a higher quality according to a user's setup.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for bit rate control for image encoding, the method comprising:
(1) dividing an entire screen into a high screen quality region and a low screen quality region and allocating a larger number of bits to the high screen quality region than to the low screen quality region;
(2) encoding a current area based on a general quantization coefficient of the current area when the current area belongs to the high screen quality region, wherein the general quantization coefficient is determined based on a comparison value between actually generated bits and bits allocated to the current area and based on a quantization coefficient of a corresponding area of a previously encoded frame; and
(3) encoding the current area by using a final quantization coefficient determined by comparing the general quantization coefficient with a maximum quantization coefficient when the current area belongs to the low screen quality region and is located adjacent to the high screen quality region, wherein the maximum quantization coefficient is predetermined based on a quantization coefficient of a high screen quality region of a previously encoded frame, and encoding the current area by using the final quantization coefficient determined with reference to a quantization coefficient of an already encoded area within a same frame when the current area is not located adjacent to the high screen quality region.

2. The method as claimed in claim 1, wherein step (1) further comprises:
dividing the entire screen into the high screen quality region and the low screen quality region according to a user's selection; and
setting bit rates allocated to the high screen quality region and the low screen quality region according to a user's selection.

3. The method as claimed in claim 1, wherein step (2) further comprises:
(a) comparing the general quantization coefficient with the maximum quantization coefficient;
(b) encoding the current area by using the maximum quantization coefficient when the general quantization coefficient is larger than the maximum quantization coefficient; and
(c) encoding the current area by using the general quantization coefficient when the general quantization coefficient is smaller than the maximum quantization coefficient.

4. The method as claimed in claim 3, wherein, in step (b), only an area, which remains after excluding a high frequency area which is to be lost in case of encoding by the general quantization coefficient after Discrete Cosine Transform (DCT) of the current macro block, is encoded by using the maximum quantization coefficient.

5. A method for bit rate control for image encoding, the method comprising:
dividing an entire screen into a high screen quality region and a low screen quality region and allocating a larger number of bits to the high screen quality region than to the low screen quality region;
encoding a current area based on a general quantization coefficient of the current area when the current area belongs to the high screen quality region, wherein the general quantization coefficient is determined based on a comparison value between actually generated bits and bits allocated to the current area and based on a quantization coefficient of a corresponding area of a previously encoded frame; and
performing encoding while skipping the current area when the current area belongs to the low screen quality region.

6. An apparatus for bit rate control for image encoding, the apparatus comprising:
a high screen quality region setup/determination unit for dividing an entire screen into a high screen quality region and a low screen quality region, allocating a larger number of bits to the high screen quality region than to the low screen quality region, and determining if a current area to be encoded belongs to the high screen quality region or the low screen quality region; and
a bit rate control unit including a high screen quality region bit rate controller and a low screen quality region bit rate controller, wherein the high screen quality region bit rate controller determines, according to control of the high screen quality region setup/determination unit, a general quantization coefficient of the current area based on a comparison value between actually generated bits and bits allocated to the current area and based on a quantization coefficient of a corresponding area of a previously encoded frame, and the low screen quality region bit rate controller determines a final quantization coefficient by comparing the general quantization coefficient with a maximum quantization coefficient when the current area belongs to the low screen quality region and is located adjacent to the high screen quality region, and determines the final quantization coefficient with reference to a quantization coefficient of an already encoded area within a same frame when the current area is not located adjacent to the high screen quality region, wherein the maximum quantization coefficient is predetermined based on a quantization coefficient of a high screen quality region of a previously encoded frame.
